(19) United States
(12) Patent Application Publication
(10) Pub. No.: US 2007/0088675 A1
(43) Pub. Date: Apr. 19, 2007

(54) Response estimation in a system with a content directory service

(75) Inventor: Bruce Duncan, Reading (GB)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/573,553

(22) PCT Filed: Sep. 27, 2004
(86) PCT No.: PCT/IB04/51878

§ 371 Date: Mar. 27, 2006

(30) Foreign Application Priority Data
Sep. 30, 2003 (GB) 0322795.6

(51) Int. Cl. G06F 17/30

(52) U.S. Cl. 707/2

(57) ABSTRACT

A querying device, such as a user interface (21), generates a query (202) for media content information from the Content Directory Service (CDS, 55) of a serving device (MS-a). A device providing a Query Estimation Service (QES, 70) also receives the query (203) and provides an estimate of at least one parameter of the response (204). This can include the expected time that the serving device (MS-a) will take to respond. The querying device provides feedback to the user corresponding to the delay, such as an appropriate form of graphical display.

This invention relates to systems which use a Content Directory Service (CDS) to store media content information, such as systems which conform to the Universal Plug and Play (UPnP) architecture.

There is an ever increasing use of digital storage devices to store media content. The media content can range from simple text files to multi-media content such as audio, pre-recorded or user-recorded video, broadcast digital audio (e.g. Internet radio), broadcast digital video or digital images (e.g. digital photos.)

Universal Plug and Play (UPnP) is a communications protocol which allows electronic devices produced by different manufacturers to operate with one another. UPnP is designed to support zero-configuration, “invisible” networking, with automatic discovery of new devices. This means a device can dynamically join a network, obtain an IP address, convey its capabilities, and learn about the presence and capabilities of other devices. A further development of UPnP is the UPnP Audio-Visual (AV) Architecture which describes extensions of the UPnP architecture relevant to Audio-Visual devices. The UPnP AV Architecture defines a Media Server, a Media Renderer and a Control Point

Many devices within a UPnP compliant network, such as a UPnP home network, contain various types of content that other devices in the network would like to access (e.g. music, videos, still images, etc). As an example, a Media Server device might contain audio, video, and still-image libraries. In order for the user to enjoy this content, the user must be able to browse the objects stored on the Media Server, select a specific one, and cause it to be played on an appropriate rendering device (e.g. an audio player for music objects, a TV for video content, an Electronic Picture Frame for still-images). For maximum convenience, it is desirable to allow the user to initiate these operations from a variety of user interface (UI) devices. In most cases, these UI devices will either be a UI built into the rendering device, or it will be a stand-alone UI device such as a remote control unit, wireless personal digital assistant (PDA) or tablet. It is desirable that a user can access the content without having to interact directly with the device containing the content.

One of the primary parts of the UPnP AV Architecture is the Content Directory Service (CDS). The CDS provides a set of features which allow UPnP Control Point (CP) devices to access the content stored on Media Server (MS) devices. The current publicly available description of CDS is the “Content Directory Service Template Version 1.01” for Universal Plug and Play Version 1.0, Jun. 25, 2002. The Content Directory Service allows clients (e.g. UI devices) to locate individual objects (e.g. songs, movies, pictures) that the server device is capable of providing. For example, this service can be used to provide a list of songs stored on an MP3 player, a list of still-images comprising various slide-shows, a list of movies stored in a DVD Jukebox, a list of TV shows currently being broadcast, a list of songs stored in a CD Jukebox, a list of programs stored on a PVR (Personal Video Recorder) device. Nearly any type of content can be listed via the CDS and multiple types of content (e.g. MP3, MPEG2, JPEG) can be listed together by the CDS.

Content is stored in a hierarchical structure of UPnP container objects, each container having a collection of objects stored within them. Each object includes media content information and a media content locator such as a Uniform Resource Identifier (URI). Although the UPnP AV Working Committee has issued a set of class definitions (see Appendix C of the “Content Directory Service Template Version 1.01” for Universal Plug and Play Version 1.0, Jun. 25, 2002), UPnP does not require a Media Server's CDS to be arranged in a particular way and so the way in which containers and objects are arranged is decided by each vendor or user. Consequently, each CDS can have a unique structure and individual objects within the structure may be labelled with different combinations of descriptive metadata. Additionally, UPnP defines two mechanisms by which a CDS can be inspected by a querying device: a “Browse” mechanism by which a querying device can browse through the CDS structure and a more useful “Search” mechanism by which a querying device can request a CDS to return items meeting specified search terms. However, the “Search” mechanism is optional and it is possible that the CDS hosted by a Media Server does not implement UPnP's optional “Search” functionality but instead requires the CP to “Browse” it's hierarchy on a container-by-container basis.

When a Control Point queries a CDS, there is an inevitable delay before a response is received. This delay includes time taken to search the CDS database for the required information, as well as time taken to collate extracted information. This delay may vary, depending on factors including the type and scale of the search, the performance of individual devices and the efficiency of communication between devices. The delay is further prolonged in situations where. the user interface is arranged in a different manner to the CDS of storage devices or where the CDS only supports the ‘browse’ operation. In both cases, the querying device must make multiple queries to extract the required information. Long delays before responses are received, as well as variability in the delays, degrades the user's experience of using the system.

Accordingly, the present invention seeks to provide an improved way of operating a system in which a content directory service is used.

A first aspect of the present invention provides a method of providing a response to a querying device in a system comprising a querying device and a serving device which uses a Content Directory Service (CDS) to store media content information, the method comprising:

receiving, from the querying device, a query for media content information from the CDS of a serving device;

deriving an estimate of at least one parameter of the response; and,

providing the estimate to the querying device.

By providing an estimate of a parameter of the response within a short, predictable timeframe, and in advance of the full response to the query, the querying device can provide the user with feedback about the response. Preferably, the parameter of the response is the response time or the size of the response, such as the number of items listed in the response. Preferably, the feedback provided by the querying device is appropriate to the likely delay.

The query can be received directly from the querying device, or it can be received via another device, such as a serving device which is the subject of the query.

The method can be performed by a device, either for internal use by that device or as a service which can be used by other devices in the system. The method can be hosted by a serving device (such as a UPnP device of the Media Server type) or any other device with processing and storage resources. The method may be hosted by a device which provides another service to devices on the network, and is particularly suited for hosting by any device which holds knowledge about serving devices on the network.

Another aspect of the invention provides a method of operating a user interface of a querying device in a system comprising a querying device and a serving device using a Content Directory Service (CDS) to store media content information, the method comprising:

sending a query for media content information from the CDS of a serving device to a device which provides an estimate of at least one parameter of the response;

receiving the estimate; and,

providing feedback to a user based on the estimate.

Further aspects of the invention provide apparatus for implementing the methods.

The functionality described here can be implemented in software, hardware or a combination of these. Accordingly, another aspect of the invention provides software for performing the method. The software may be stored on an electronic memory device, hard disk, optical disk or other machine-readable storage medium and will be executed by a suitable processing device on the host device. The software may be delivered as a computer program product on a machine-readable carrier or it may be downloaded directly to the host device via a network connection. It will be appreciated that the software may be installed at any point during the life of the host device.

The term ‘Content Directory Service’ (CDS) is intended to include the CDS used in UPnP systems, but it is not to be taken as limited to just UPnP systems. It can include any CDS-like storage system for media content information which has a hierarchical structure that is loosely defined and thus unpredictable and difficult for querying devices to extract required information from.

Embodiments of the present invention will now be described, by way of example only, with reference to the accompanying drawings, in which:

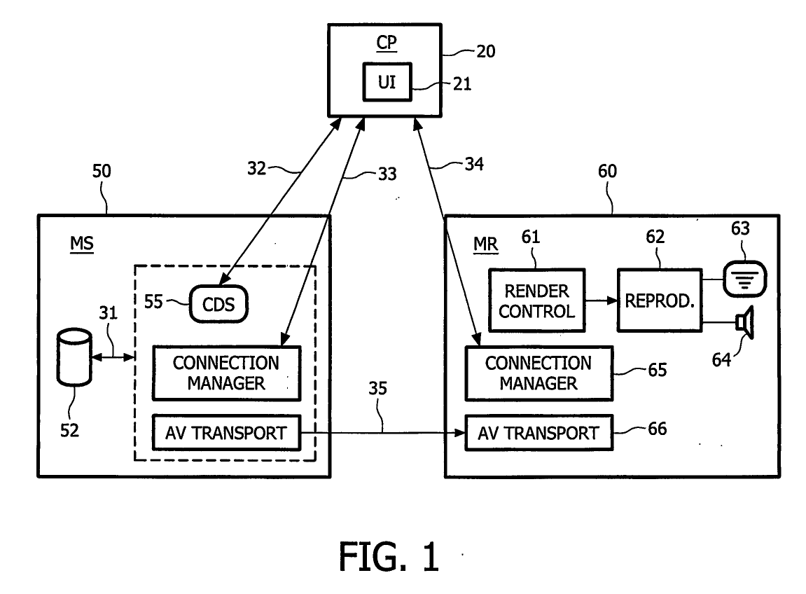

FIG. 1 shows the main components of a UPnP system;

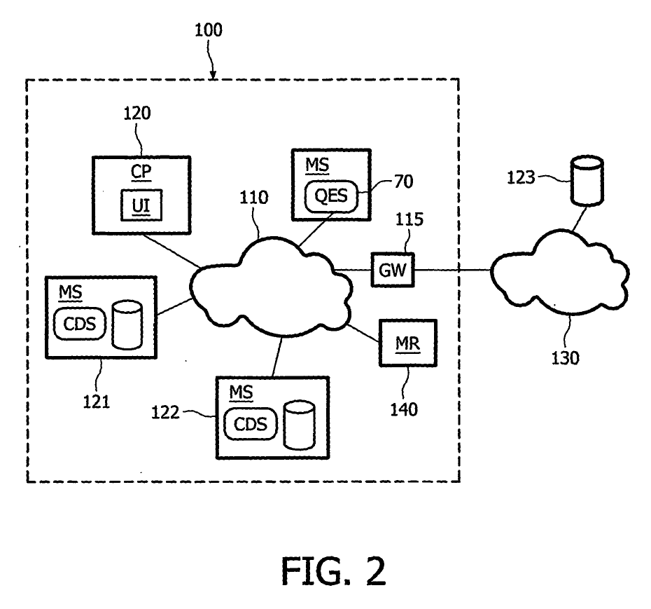

FIG. 2 shows a network of UPnP devices;

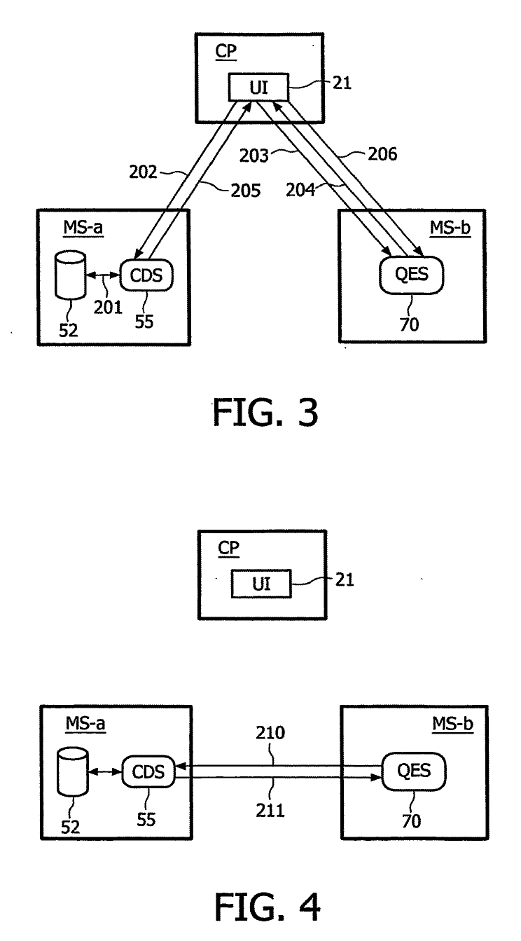

FIGS. 3 and 4 show a first embodiment of a system which includes a query estimation service in accordance with the invention;

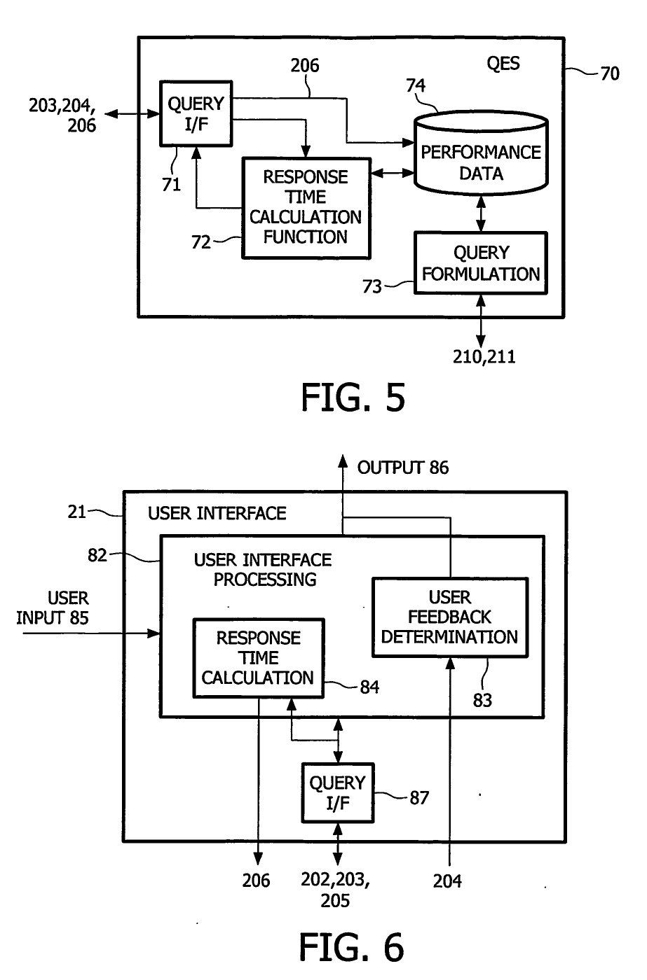

FIG. 5 shows the main functional blocks of the query estimation service;

FIG. 6 shows the main functional blocks of a user interface;

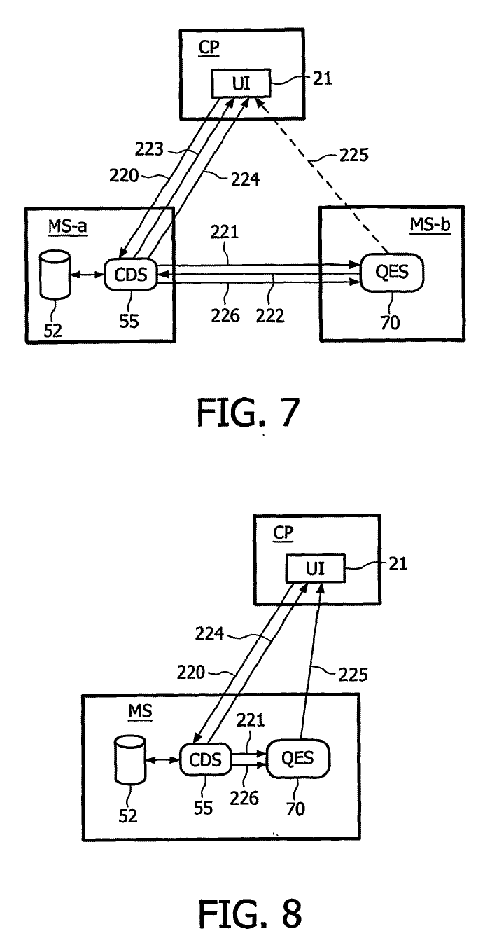

FIGS. 7-9 show alternative embodiments of a system which includes a query estimation service in accordance with the invention;

FIGS. 10-13 show different types of feedback which can be presented by the user interface of FIG. 6; and,

FIG. 14 shows an example structure of a content directory service (CDS).

Before describing the invention in detail, a conventional UPnP system will be briefly described. A more thorough explanation can be obtained from “UPnP AV Architecture” published by the UPnP Forum. The main components of a UPnP AV system are a Control Point (CP) 20, a Media Server (MS) 50 and a Media Renderer (MR) 60. All of these are logical entities: a physical device may include only one of these entities (e.g. a Control Point in the form of a remote control) or, more commonly, a combination of several of these entities. As an example, a CD player comprises a user interface and control circuitry for operating the player (a Control Point), apparatus for reading digital content from an optical disk (a Media Server) and apparatus for converting the digital content into an audio signal for presentation to a user (a Media Renderer).

Media Server (MS) 50 includes a store 52 of media content. The content can include, for example, audio, video, still images or a combination of these. The Media Server also supports a Content Directory Service (CDS) 55 which catalogues the content in store 52. The CDS is hierarchically organised in a manner similar to a computer file system. A container (analogous to a folder or directory) can include a plurality of objects (analogous to a file) and containers that are hierarchically one level lower. The object includes an object description with an identifier and optionally metadata. The metadata may include properties such as object name, artist, composer, date created, size, etc. The object may also include the object content (item) or include a locator, such as a URI, for locating the content. An example CDS structure is shown in FIG. 14. Further functions of the Media Server 50 are a Connection Manager Service which is used to manage connections between the Media Server 50 and other devices, such as the Media Renderer 60. An optional AV Transport Service allows control of the playback of content, with features such as stop, pause, seek etc.

Media Renderer (MR) 60 is responsible for rendering (reproducing) media content which is received from a Media Server 50. Reproduction equipment 62 is shown with a display 63 and speaker 64 although the output can take many forms. Typically, the reproduction equipment 62 includes one or more decoders, digital to analog converter and amplifiers. The Media Renderer 60 also supports a Connection Manager Service 65 for establishing a new connection with a Media Server and Render Control 61 for controlling the way in which the content is rendered. For audio reproduction this can include features such as a volume control.

Control Point (CP) 20 coordinates operation of the Media Server 50 and Media Renderer 60 and includes a user interface (UI) 21 by which a user can select content. The Control Point 20 supports the conventional UPnP mechanisms for discovering new devices and also supports mechanisms for finding the capabilities of Media Rendering devices and establishing connections between a Media Server and a Media Renderer. The UPnP AV Architecture supports a wide variety of AV devices such as TVs, VCRs, CD/DVD players/jukeboxes, set-top boxes, stereo systems, MP3 players, still-image cameras, camcorders, electronic picture frames (EPFs), and the PC. The AV Architecture allows devices to support different types of formats for the entertainment content (such as MPEG2, MPEG4, JPEG, MP3, Windows Media Architecture (WMA), bitmaps (BMP), NTSC, PAL, ATSC, etc.) and multiple types of transfer protocols (such as IEC-61883/IEEE-1394, HTTP GET, RTP, HTTP PUT/POST, TCP/IP, etc.).

Multiple physical devices, each having one or more or the CP, MS and MR entities, can be operated together as a network. FIG. 2 shows an example of a UPnP network which can represent a network of devices within a home. A Control Point 120, two Media Server devices 121, 122 and a Media Renderer device 140 are networked 110 together. The network 110 can be wired (e.g. Ethernet) or wireless (e.g. IEEE 802.11, Bluetooth). The media content can be wholly located on servers within the home network 100 or it can be located outside the home network 100. FIG. 2 shows a server 123 for storing content which is part of an external network 130, such as the Internet. This external server 123 is connected to the home network via a gateway 115.

Referring again to FIG. 1, this shows a conventional arrangement for accessing content over a UPnP network. The Media Server MS 50 maintains a Content Directory Service (CDS) 55 by interaction 31 with the local storage device 52. The Media Server 50 structures the CDS in a particular way, which may be dictated by the manufacturer of the MS. The CDS is updated as new content is added to the store 52. At some later time, a user interacts with user interface 21. Typically, the user interface 21 will present the user with a menu of possible options. As an example, an initial menu screen may ask the user whether they wish to retrieve audio content, video content or an image. In response to user selections at UI 22, the CP makes an appropriate query 32 of the CDS 55 of the MS 50. MS 50 responds with the required listing of content. When the user selects a piece of content, the CP instructs 33, 34 the MS and the MR to arrange an appropriate connection 35 and to begin streaming the content from the MS to the MR.

Referring again to FIG. 2, the network also includes a query estimation service QES 70, in accordance with the invention. The QES is hosted by a device within the network and provides a service to any devices within the network which require it. In the context of a UPnP system, the host is a device of the Media Server type. FIG. 3 shows the operation of a first embodiment of a system in which a QES is provided. For clarity, the Figure only shows one Control Point CP, a Media Server MS-a and a Media Server ME-b hosting the QES. In use, a user interacts with the user interface (UI) 21 of Control Point CP. The Control Point can be hosted by a remote control, a PDA, a PC or the UI of an appliance. In response to user selections, the UI 21 generates a query 202 for media content information. The CP sends its query to both the CDS of MS-a (message 202) and to the QES (message 203) of MS-b. Upon receipt of the query, the QES prepares an estimate of the time that it will take MS-a to respond. The QES makes use of performance data stored in MS-b. The estimate of the response time is sent directly to CP as message 204. Upon receiving the estimate of the response time, the UI 21 presents the user with feedback which is appropriate to the length of the estimated delay. When the CDS on MS-a has prepared the results to the query, they are returned as message 205. UI displays the results and the CP can then send a message 206 to the QES indicating the actual time that the MS took to respond to the query. In this manner, the QES can update its performance data and/or adjust the parameters of the estimation algorithm used by the QES.

The QES can acquire performance data solely on the results of actual queries that it receives, with the quality of estimates improving with the number of queries. The QES can also perform queries of its own, shown as a query 210 and response 211 in FIG. 4. There can be a standard, pre-programmed, set of queries for the QES to perform. This will be particularly useful when the QES has just been started in a new network and has not had an opportunity to acquire any performance data from actual queries. A sequence of probe queries can start with very simple queries to establish overall parameters of the CDS, such as: a best-case communication time with the CDS by sending a query to browse the root (highest level) container of the CDS; and the overall scale of the CDS by sending a query, or series of queries, to search or recursively browse for the ID of every content item in the database. The next round of probe queries can request listings for those categories of object which are likely to be represented as containers within a CDS structure, e.g. request listings for all items of a particular content type, or all artists or all genres represented in the CDS. Further probing can involve search criteria which are likely to be held as object-specific metadata, rather than being explicitly represented in the CDS structure, e.g. a search for items released in a specific year. This could be repeated for the whole database and for each of the structural categories mentioned above. More elaborate probing can involve requesting items which satisfy combinations of criteria, returning different numbers of responses and different depths of information for each response.

Response times can be affected by fluctuations in network traffic, so the sequence of probe queries should preferably be repeated several times, ideally under different network loading conditions, in order to estimate this variability.

FIG. 5 shows the QES in more detail. A query interface function 71 receives queries 203 and issues responses 204. Performance data from actual queries is stored in storage device 74. The performance data can include the identity of the queried device (e.g. MS-a), the nature of the query (e.g. retrieving an audio item with the title “X”) and the actual time to respond. Performance data 74 is updated by messages 206 which indicate the actual time taken for a MS to respond to a query. A query formulation unit 73 can issue queries of its own in the manner just described, either to acquire an initial bank of useful data or to supplement existing data.

The QES bases it's estimate of a query response time on previous performance statistics for similar queries. This can be realised in a number of ways.

In it's simplest form, the QES can be implemented as a look up table which compares the current query with previous queries, in storage 74, and determines the best match. The stored response time corresponding to the stored query having the best match can be provided as an estimate of the response time for the current query. It will be appreciated that the accuracy of this technique improves as the quantity of stored results increases. Information is stored for each CDS.

In another embodiment, each CDS for which the QES holds information can be classified into one of a set of classes. Each CDS class has a response time estimation algorithm matched to that class. A CDS can be classified according to a set of decision rules based on comparisons of response times to probe queries. The classes may represent, for example, a fast CDS with a large population, a slow CDS etc.

In a further embodiment there can be a single response time estimation algorithm which derives an estimated response time. Parameters of the algorithm are varied according to known properties of the CDS and the current query. Parameters of the algorithm can take into account:
the structure of the CDS (e.g. well organised categorized structure or simple, flat, structure);
the population (number of entries) of the queried CDS;
the searching capabilities of the queried CDS (e.g. browse only or search and browse);
metadata availability (e.g. knowledge of what metadata is supported, and what is not supported.)
the current query (e.g. difficulty of request, amount of data requested).

Statistical analysis of variance on the results of the probe queries could identify those factors which exert greatest influence on the response time, and a set of decision rules for classifying the CDS could be derived from this. It is also possible to train a neural network to recognize those types of queries which require each of the different UI behaviours.

Information about CDSs can be obtained from other devices in the network which make use of such information. In particular, a device hosting a translator CDS service, as described in co-pending patent application [Philips Ref. ID403117] can provide information about structure, population, searching capabilities and metadata availability in of CDSs in a network. This information can also be obtained by the QES actively investigating CDSs in the network, such as by querying them of it's own accord using query formulation unit 73.

To illustrate the variation in response times, several examples will now be considered. A first query is for titles of the first ten music items stored in the CDS of a particular storage device. The QES knows that this CDS stores all music items in a single container. The request is straightforward, the information will be easy to find and so this should be a very quick query. A second query asks for the complete details of every music item from the same CDS. The QES knows that the CDS has a population of 250 items and each item includes an extensive list of metadata. Although the information will not be difficult to find, there is a considerable quantity of information to extract and so this query will take considerably longer. A third query asks for a music item having the release date of “Y” in a particular CDS. The QES knows that this CDS does not contain metadata carrying that information. This query will take a long time since the information does not exist. Most probably, the user interface or CDS would time out after a particular length of time. In a further development of the invention, the QES can be arranged to issue a special form of feedback where the QES's knowledge of the CDS shows that the query cannot be answered. The feedback can take the form of a message to the user to abort the current query or it can take the form of a control message to the querying device to abort the current query.

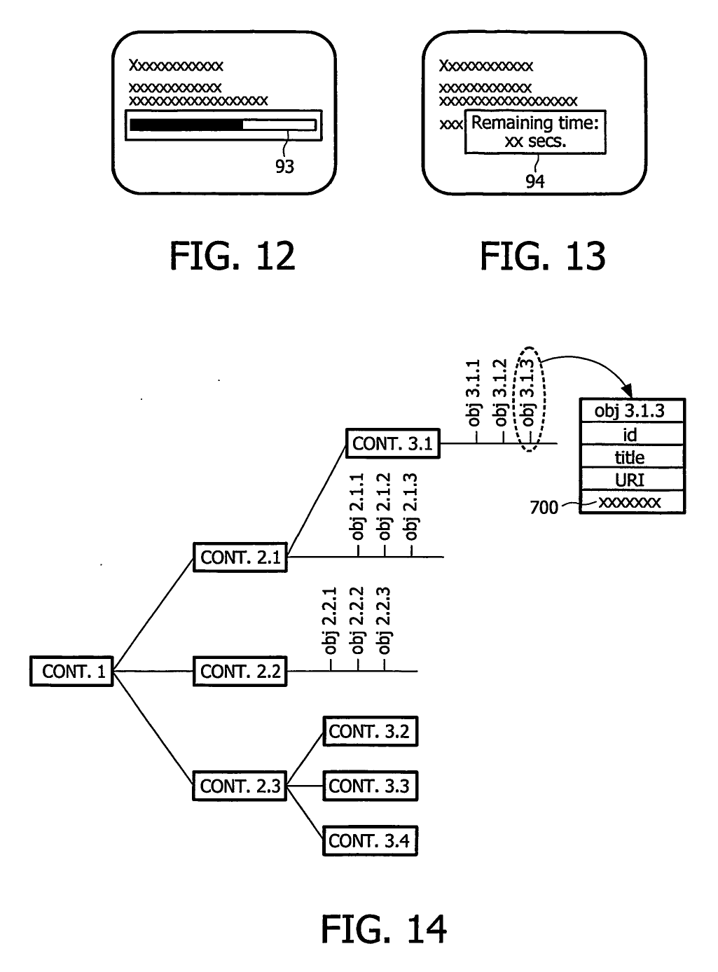

FIG. 6 shows the main functional blocks of the user interface 21. A user interface processing unit 82 receives user inputs 85, such as selections made on a keyboard, by a mouse or on a touch sensitive screen, and issues outputs 86, such as graphical data for display on a screen and audible prompts. The processing unit 82 controls the generation of menus and responds to user selections in a known manner. User selections are translated, by a query interface 87, into queries of an appropriate format for conveying over the network. Similarly, responses received by the query interface 87 are converted into a suitable form for use by the processing unit 82. The estimated response time 204 from the QES is received by a feedback determination unit 83. This determines what form of feedback should be issued to the user via output 86. The feedback to the user can take a number of forms. FIGS. 10-13 show four examples of possible feedback. The type of feedback will depend on the type of user interface (e.g. graphical based, audio based) and the length of the estimated delay. As an example, a graphical based UI can use three different types of feedback, each associated with a range of delays, as shown in the table below:

| Length of delay/ | |
|---|---|
| seconds | User Feedback |
| <1 | Nothing |
| 1-5 | Egg timer (91, FIG. 10)/ |
| | Please wait message (92, FIG. 11) |
| >5 | Progress bar (93, FIG. 12)/ |
| | count down timer (94, FIG. 13) |

It will be appreciated that the number of different types of feedback and the threshold delay values which determine when each type of feedback is used can be varied according to the requirements of a particular system or user preferences. For short delays it is preferred that the user interface does not display any feedback as the user will not have sufficient time to interpret the feedback before the arrival of the results. A response time calculation unit 84 monitors the time delay between sending a query 202 and receiving the reply 205. A simple timer can be used. The time recorded by unit 84 is sent 206 in a message to the QES.

FIGS. 7 and 8 show two alternative embodiments of the invention where the queried CDS and QES are able to communicate directly with each other. Considering FIG. 7, in operation the CP sends a query 220 for media content information to the CDS in a conventional manner. No second query needs to be sent to the QES as the CDS 55 passes the query on to the QES 70, shown as message 221. The QES prepares an estimate, as described previously, and returns this 222, 223 to the CP via the CDS 55. Alternatively, the estimate can be sent directly to the querying CP as message 225. Subsequently, the CDS sends the results of the query to the CP, as message 224, and also to QES 70, as message 226. From this, the QES can calculate the actual time taken to respond and can update it's performance data/estimation algorithm.

FIG. 8 works in a similar manner, and the same message flows have been given the same numbers. The main difference in this embodiment is that the CDS 55 and QES 70 are both located within the same device MS and communicate with one another via an internal channel.

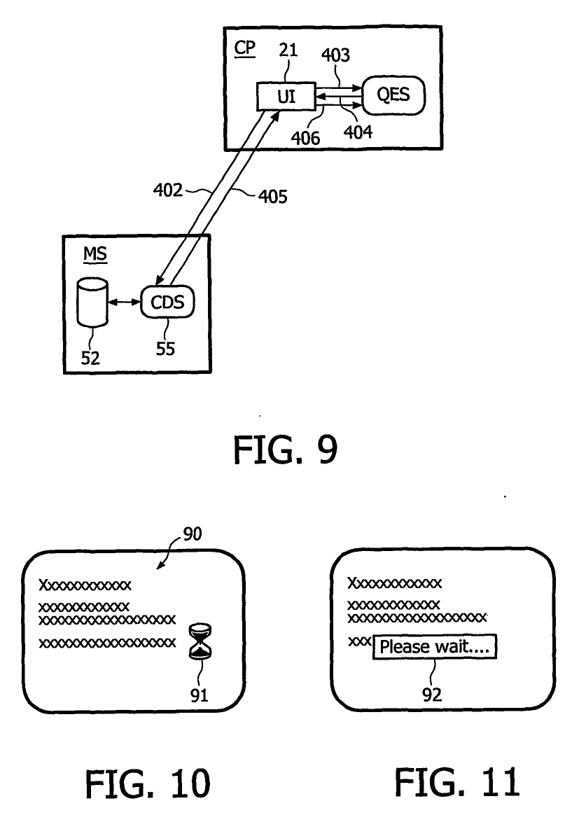

FIG. 9 shows a further alternative embodiment in which the QES is hosted by the CP. In this case, the QES 70 can exist solely as an internal service to the CP or as a network-accessible service to other devices. Since the QES is not a defined service of any standard UPnP device, it could be offered as an extra service by any type of device.

The CP sends its query 402 to the CDS, and the query is also passed 403, by an internal channel, to the QES. The QES prepares its estimate, which is made available 404, by an internal channel, to the UI controller. When the query results are ready, the CDS sends them to the CP as message 405. The QES also receives the result as message 406 and uses this to update it's performance data/estimation algorithm.

The above embodiments describe how the QES can provide an estimate of a response time. The QES can alternatively, or additionally, provide estimates of other parameters of the query, including, for example, an estimate of the number of responses to the query. It can be useful for a UI to know that a query is likely to return a listing with a very large number of entries. In this case, as soon as the QES returns an estimate of the size of the response, the UI can generate a display which is appropriate to the expected number of results. This can include a results window of an appropriate size and appropriate cues or controls for navigating the expected number of results. As an example, for particularly long listings the UI can display a large window with slider bars, to prepare the user for this particular task in advance of the actual listing being available. Operating in this manner further helps to improve the usability and perceived responsiveness of the UI.

For completeness, FIG. 14 shows an example structure of a Content Directory Service (CDS) of a MS. The CDS has a hierarchical structure of containers and objects. Containers hold multiple objects, e.g. a music album is a container holding multiple audio objects. As illustrated, containers can hold further sets of containers (as with container 2.3 holding containers 3.2, 3.3, 3.4) or multiple objects. Each object is defined by a number of properties. One such object, Object 3.1.3, is shown in more detail. In UPnP the properties must include an identifier such as an ‘id’ and ‘title’ (name). The object can include a Uniform Resource Identifier (URI) which points to the location of the media object. The object may be stored in the storage device within the Media Server (e.g. store 52 in FIG. 1) or in a server externally of the Media Server. A property of a container is a field which indicates whether the container can be searched. Further properties, including metadata 700, can also be included in the information.

1. A method of providing a response to a querying device in a system comprising a querying device and a serving device which uses a Content Directory Service (CDS) to store media content information, the method comprising:
receiving, from the querying device, a query for media content information from the CDS of a serving device;
deriving an estimate of at least one parameter of the response; and,
providing the estimate to the querying device.

2. A method according to claim 1 wherein the step of deriving an estimate to the query uses knowledge of previous querying performance of the serving device.

3. A method according to claim 2 wherein the knowledge of previous querying performance of the serving device is acquired by performing sample queries on the serving device.

4. A method according to claim 2 wherein the knowledge of previous querying performance of the serving device is acquired by storing performance data of previous queries.

5. A method according to claim 4 wherein the knowledge of previous querying performance includes feedback from querying devices, indicative of actual performance of the serving device.

6. A method according to claim 1 wherein the step of deriving an estimate uses knowledge of the CDS of the serving device.

7. A method according to claim 6 wherein the knowledge of the CDS comprises one or more of: structure of the CDS, population of the CDS, searching capabilities of the CDS, metadata availability, capacity of a communication link between the querying device and the serving device.

8. A method according to claim 6 wherein the knowledge of the CDS is acquired from another device, other than the serving device hosting the CDS.

9. A method according to claim 1 wherein the parameter is a time for the serving device to respond to the query.

10. A method according to claim 1 wherein the parameter is the size of the response.

11. A method according to claim 1 wherein the querying device is a device which hosts a user interface and the method is performed by the querying device.

12. A method according to claim 1 which is performed by a device other than the querying device.

13. A method according to claim 1 which is performed as a service on behalf of a plurality of querying devices in the system.

14. A method of operating a user interface of a querying device in a system comprising a querying device and a serving device using a Content Directory Service (CDS) to store media content information, the method comprising:
sending a query for media content information from the CDS of a serving device to a device which provides an estimate of at least one parameter of the response;
receiving the estimate; and,
providing feedback to a user based on the estimate.

15. A method according to claim 14 wherein the parameter is a time for the serving device to respond to the query and the feedback depends on the length of the response time.

16. A method according to claim 15 wherein there are a plurality of different possible types of feedback, each type of feedback being associated with a particular range of response time.

17. A method according to claim 14 wherein the feedback comprises a display which indicates the remaining time.

18. A method according to claim 14 wherein the parameter is size of the response and the feedback is at least one navigation control based on the size of the response.

19. Software for causing a processor to perform the method according to claim 1.

20. Apparatus for providing information to a querying device in a system comprising a querying device and a serving device using a Content Directory Service (CDS) to store media content information, the apparatus comprising:
means for receiving, from the querying device, a query for media content information from the CDS of a serving device;
means for deriving an estimate of at least one parameter of the response; and,
means for providing the estimate to the querying device.

21. Apparatus according to claim 20 wherein the means for deriving an estimate to the query uses knowledge of previous querying performance of the serving device.

22. Apparatus according to claim 22 which is arranged to acquire the knowledge of previous querying performance of the serving device by performing sample queries on the serving device.

23. Apparatus according to claim 21 which is arranged to acquire the knowledge of previous querying performance of the serving device by storing performance data of previous queries.

24. Apparatus according to claim 23 wherein the knowledge of previous querying performance includes feedback from querying devices, indicative of actual performance of the serving device.

25. Apparatus according to claim 20 wherein the means for deriving an estimate uses knowledge of the CDS of the serving device.

26. Apparatus according to claim 25 wherein the knowledge of the CDS comprises one or more of: structure of the CDS, population of the CDS, searching capabilities of the CDS, metadata availability, capacity of a communication link between the querying device and the serving device.

27. Apparatus according to claim 25 which is arranged to acquire the knowledge of the CDS from another device, other than the serving device hosting the CDS.

28. Apparatus according to claim 20 wherein the parameter is a time for the serving device to respond to the query.

29. Apparatus according to claim 20 wherein the parameter is the size of the response.

30. Apparatus according to claim 20 in the form of a querying device which hosts a user interface.

31. Apparatus according to claim 20 in the form of a device which is physically separate from the querying device.

32. Apparatus according to claim 20 which is accessible by a plurality of querying devices in the system.

33. A user interface of a querying device for use in a system comprising the querying device and a serving device which uses a Content Directory Service (CDS) to store media content information, the user interface comprising:
means for sending a query for media content information from the CDS of a serving device to a device which provides an estimate of at least one parameter of the response;
means for receiving the estimate; and,
means for providing feedback to a user based on the estimate.

34. A user interface according to claim 33 wherein the parameter is a time for the serving device to respond to the query and the feedback depends on the length of the response time.

35. A user interface according to claim 34 wherein the means for providing feedback is arranged to provide a plurality of different possible types of feedback, each type of feedback being associated with a particular range of response time.

36. A user interface according to claim 33 wherein the means for providing feedback is arranged to provide a display which indicates the remaining time.

37. A user interface according to claim 33 wherein the parameter is size of the response and the means for providing feedback is arranged to provide at least one navigation control based on the size of the response.

38. A querying device hosting the user interface according to claim 33.

39. A method, software, apparatus, user interface or device according to claim 1 for use in a system which conforms to Universal Plug and Play (UPnP).
